(19) United States
(12) Patent Application Publication
(10) Pub. No.: US 2016/0262017 A1
(43) Pub. Date: Sep. 8, 2016

(54) PERSONAL ASSISTANT AUTHENTICATION

(71) Applicant: MICROSOFT TECHNOLOGY LICENSING, LLC, REDMOND, WA (US)

(72) Inventors: GAL LAVEE, TEL AVIV (IL); ROYI RONEN, TEL AVIV (IL); RONEN YAARI, TEL AVIV (IL)

(21) Appl. No.: 14/637,526

(22) Filed: Mar. 4, 2015

(51) Int. Cl. H04W 12/06; H04L 29/06; G06F 21/31; H04L 29/08; H04W 88/02

(52) U.S. Cl. CPC H04W 12/06; H04L 67/10; H04W 88/02; G06F 21/31; H04L 63/083

(57) ABSTRACT

Aspects of the technology described herein provide a mechanism to authenticate a task request received by a personal digital assistant. The authentication mechanism improves security for transactions facilitated by the personal digital assistant. The authentication mechanism can also improve machine and user efficiency by streamlining a transaction process. In one aspect, the request is a verbal request made by a person and received by the personal digital assistant through a microphone. The personal assistant can generate an authentication questions using data from a semantic knowledge base accessible to the personal digital assistant.

### BACKGROUND

A personal digital assistant program provides services traditionally provided by a human assistant. For example, a personal digital assistant can update a calendar, provide reminders, track activities, and perform other functions. Some personal digital assistant programs can respond to voice commands and audibly communicate with users.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The technology described herein provides a mechanism to authenticate a task request received by a personal digital assistant. The authentication mechanism improves security for transactions facilitated by the personal digital assistant. The authentication mechanism can also improve machine and user efficiency by streamlining a transaction process.

In one aspect, the request is a verbal request made by a person and received by the personal digital assistant through a microphone. The request may be processed to extract a task and an online service through which the task is to be performed. For example, the request may be for the personal digital assistant to order groceries from Bob's grocery store. Other information, such as details of the grocery order and a requested time to pick up may be included in the request. Alternatively, the personal digital assistant may request further details as needed. In this example, the task is “order groceries” and the online service provider is “Bob's grocery store.” Bob's grocery store can have a brick-and-mortar location and still be designated as an online service provider because business transactions can be conducted, at least in part, through an online interface.

In the example above, the automated ordering can provide a great deal of convenience to the user but also poses a security concern. For example, the personal digital assistant may need to provide user credentials and payment information to process the task. Aspects of the technology described herein can provide the personal digital assistant access to user account and payment information upon authentication of the request. The user account information can then be provided to online providers.

### BRIEF DESCRIPTION OF THE DRAWINGS

Aspects of the technology described in the present application are described in detail below with reference to the attached drawing figures, wherein:

FIG. 1 is a block diagram of an exemplary computing environment suitable for implementing aspects of the technology described herein;

FIG. 2 is a diagram depicting an exemplary computing environment within a user device comprising a personal assistant module capable of authenticating a user request, in accordance with an aspect of the technology described herein;

FIG. 3 is a diagram depicting an exemplary computing environment comprising multiple computing devices wherein security data is stored in a data center, in accordance with an aspect of the technology described herein;

FIG. 4 is a diagram depicting an exemplary computing environment comprising multiple computing devices wherein security data is stored in a data center and on a user device, in accordance with an aspect of the technology described herein;

FIG. 5 is a diagram depicting an exemplary computing environment comprising multiple computing devices wherein security data is stored in a data center and the data center has an action module to facilitate performance of a requested task, in accordance with an aspect of the technology described herein;

FIG. 6 is a diagram depicting an exemplary computing environment comprising multiple computing devices wherein security data is stored in a data center and on one of two user devices, in accordance with an aspect of the technology described herein;

FIG. 7 is a diagram depicting an exemplary computing environment comprising multiple computing devices wherein security data is stored on a user device, in accordance with an aspect of the technology described herein;

FIG. 8 is a diagram depicting a method of authenticating a request received by a personal digital assistant application, in accordance with an aspect of the technology described herein; and

FIG. 9 is a diagram depicting a method for authorizing a digital personal assistant to conduct a transaction with a third party, in accordance with an aspect of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein can provide a mechanism to authenticate a task request received by a personal digital assistant. The authentication mechanism improves security for transactions facilitated by the personal digital assistant. The authentication mechanism can also improve machine and user efficiency by streamlining a transaction process.

In one aspect, the request is a verbal request made by a person and received by the personal digital assistant through a microphone. The request may be processed to extract a task and an online service through which the task is to be performed. For example, the request may be for the personal digital assistant to order groceries from Bob's grocery store. Other information, such as details of the grocery order and a requested time to pick up may be included in the request. Alternatively, the personal digital assistant may request further details as needed. In this example, the task is “order groceries” and the online service provider is “Bob's grocery store.” Bob's grocery store can have a brick-and-mortar location and still be designated as an online service provider because business transactions can be conducted, at least in part, through an online interface.

In the example above, the automated ordering can provide a great deal of convenience to the user but also poses a security concern. For example, the personal digital assistant may need to provide user credentials and payment information to process the task. The technology described herein can provide the personal digital assistant access to user account and payment information upon authentication of the request. The user account information can then be provided to online providers.

The authentication mechanism described herein can authenticate a user request to the personal digital assistant and/or authenticate the personal digital assistant to an online service provider as having authority to act on behalf of a user. In general, a personal digital assistant may be accessible to a person that has gained access to a user device on which the personal digital assistant is running. For example, a mobile phone may be password-protected, but the individual applications, including the personal digital assistant, may be unprotected once the phone is unlocked. The technology described herein can provide an additional authentication mechanism to validate that a user interacting with a personal digital assistant is the person authorized to use the personal digital assistant. Once a request is authenticated as coming from the person authorized to use the personal digital assistant, the personal digital assistant may proceed with facilitating completion of the requested task. Absent proper authentication, the personal digital assistant will not complete the task. The authorization mechanism may apply only to certain tasks and requests. As described subsequently, the tasks and requests that require authorization may be designated by a user. Additionally, different levels of authorization may be applied to different tasks and requests. Online providers may also be able to establish an acceptable authentication level.

In one aspect, user credentials including usernames and passwords for online services are not accessible to the personal digital assistant without satisfaction that the request is from an authorized user. The user credentials and usernames may be kept in a separate security data store that is only accessible upon satisfaction of an authentication procedure assigned to a particular task and/or online provider. The security data and/or user credentials may be stored remotely in a data store that requires a token or other message from the personal digital assistant confirming that the authentication was successful to grant access. In another aspect, the user credentials may be stored on the same device running the personal digital assistant application, but an authentication layer is present between the personal digital assistant and the secure data.

Different authentication procedures may apply to different tasks. Different authentication procedures may be used for different online providers even when the same task is being performed. For example, a more rigorous authentication procedure may be applied when interacting with a first online provider than when interacting with a second online provider.

The authentication mechanism can also validate the personal digital assistant to an online provider. Typically, an online provider may provide a web page or application through which a user can complete transactions with the online provider. The online provider may have an authentication procedure, such as requiring the submission of a password. The online provider may also have security mechanisms in place to make sure that a human is guiding the interaction rather than a bot. Completely Automated Public Turing test to tell Computers and Humans Apart (“CAPTCHA”) is one technology currently employed for this purpose. Accordingly, a personal digital assistant may not be able to use a traditional interface to complete transactions with the online provider. In one aspect, an online provider may receive transaction requests through an interface designed to work with personal digital assistants. The personal digital assistant interface can receive user credentials and other task details. The personal digital assistant interface can also require a token that validates that an appropriate authentication procedure has occurred successfully. The personal digital assistant can use an authentication component to generate this token and communicate it to the online provider.

Having briefly described an overview of aspects of the technology described herein, an exemplary operating environment suitable for use in implementing the technology is described below.

### Exemplary Operating Environment

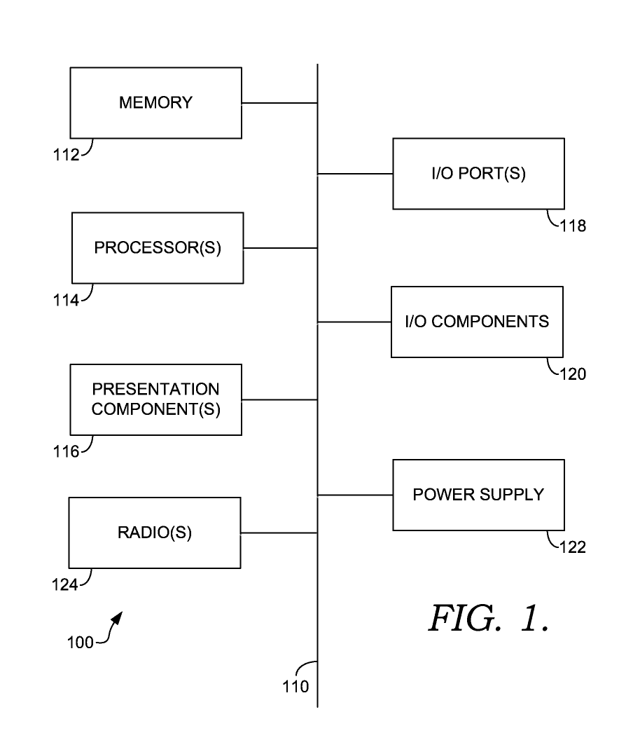

Referring to the drawings in general, and initially to FIG. 1 in particular, an exemplary operating environment for implementing aspects of the technology described herein is shown and designated generally as computing device 100. Computing device 100 is but one example of a suitable computing environment and is not intended to suggest any limitation as to the scope of use of the technology described herein. Neither should the computing device 100 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or a combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112, or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices, including I/O components 120, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In embodiments, a pen digitizer (not shown) and accompanying input instrument (also not shown but which may include, by way of example only, a pen or a stylus) are provided in order to digitally capture freehand user input. The connection between the pen digitizer and processor(s) 114 may be direct or via a coupling utilizing a serial port, parallel port, and/or other interface and/or system bus known in the art. Furthermore, the digitizer input component may be a component separated from an output component such as a display device, or in some embodiments, the usable input area of a digitizer may coexist with the display area of a display device, be integrated with the display device, or may exist as a separate device overlaying or otherwise appended to a display device. Any and all such variations, and any combination thereof, are contemplated to be within the scope of embodiments of the technology described herein.

An NUI processes air gestures, voice, or other physiological inputs generated by a user. Appropriate NUI inputs may be interpreted as ink strokes for presentation in association with the computing device 100. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

A computing device may include a radio. The radio transmits and receives radio communications. The computing device may be a wireless terminal adapted to receive communications and media over various wireless networks. Computing device 100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

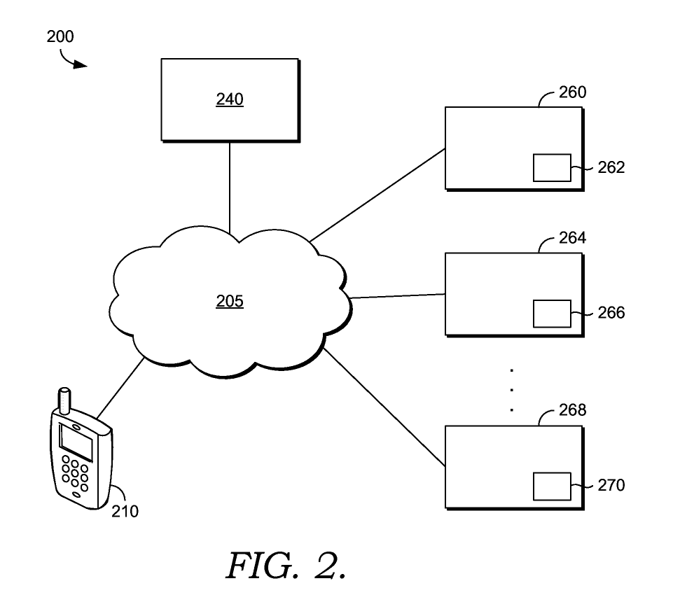

Turning now to FIG. 2, an exemplary wide area computing environment 200 is shown, in accordance with an aspect of the technology described herein. The computing environment 200 includes a mobile device 210 connected through wide area network 205 with personal assistant server 240 and a first online service provider 260, a second online service provider 264, and a third online service provider 268. In an aspect of the technology described herein, the mobile device 210 can communicate through network 205 with one of the online service providers to request the performance of a task. Exemplary tasks have been described above and can include making a purchase, requesting information, making a reservation, and such. A personal digital assistant running on the mobile device 210 can interface with the online services to make a request. In one aspect, the personal digital assistant needs to perform an authentication procedure that ensures that the request is received from an authorized user of the mobile device and an account associated with the online service. The personal digital assistant may provide proof, in the form of a security certificate, that the authentication procedure has been performed.

The online service can provide an interface for the personal digital assistant or other applications to make requests and receive confirmation of the authentication procedure. In the example shown, the first online service 260 includes an application interface 262. The second online service 264 includes an application interface 266. The third online service 268 includes an application interface 270.

In another aspect of the technology described herein, the personal assistant server 240 can facilitate communication of the request and performance of an task. The personal assistant server 240 can perform the authentication of a request received at the mobile device and provide evidence to the online service that the authentication has occurred.

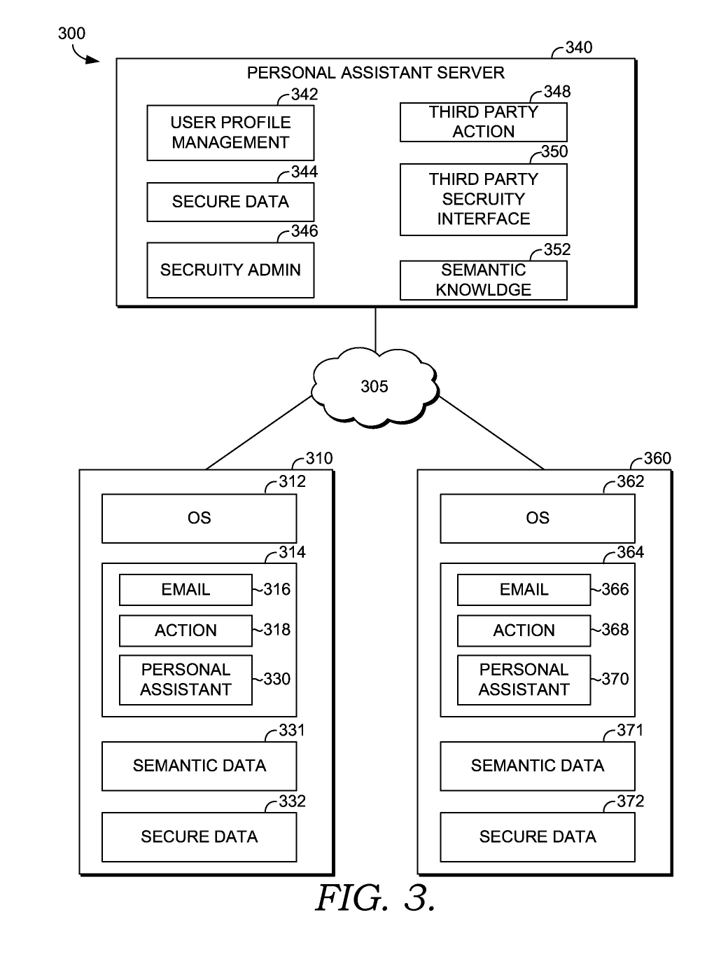

Turning now to FIG. 3, a computing environment for authentication of a personal digital assistant is described, in accordance with an aspect of the technology described herein. The computing environment 300 includes a mobile device 310 and a personal computer 360 both belonging to the same user. The mobile device 310 and the personal computer 360 are communicatively coupled to a personal assistant server 340 through wide area network 305. In one aspect, the wide area network 305 is the Internet.

The mobile device 310 includes an operating system 312, an applications layer 314, and secure data component 332. The mobile device 310 also includes numerous other components that are not shown for the sake of simplicity. The mobile device 310 and/or the personal computer 360 may be similar to the computing device 100 described previously with reference to FIG. 1.

The applications layer 314 includes an e-mail application 316, an action application 318, and a personal digital assistant application 330. Only three applications are shown for the sake of simplicity. A mobile device 310, as is known, could have tens or hundreds of applications.

The e-mail application 316 sends and receives e-mails, can track contacts, can track and manage one or more calendars for the users, and can manage tasks, among other functions. The e-mail application 316 could manage e-mails from multiple e-mail accounts.

The action application 318 is able to perform online activities, such as making restaurant reservations, perform online banking tasks, perform online shopping tasks, etc. Again, actual implementations may include multiple action applications, but one is shown for the sake of simplicity. For example, each online service could have a dedicated action application through which a task can be performed.

The personal digital assistant application 330 helps the user perform tasks through the one or more computing devices, such as mobile device 310 and the personal computer 360, associated with the user. A user is associated with the computing device when she uses the computing device on a regular basis. The user does not need to own the computing device, for example, a user's work computer could be owned by the employer but, nevertheless, be considered “associated with the user.” Similarly, a user could share a family computer with multiple people, and the family computer can be considered “associated with the user.” In one aspect, a user is able to designate the devices that he or she is associated with. In one aspect, a user is associated with each device on which an instance of the personal assistant application is installed and on which the user has registered his or her account information or user identification with the personal digital assistant application.

The personal digital assistant application 330 can help the user complete both computing tasks, such as sending an e-mail or submitting a search query, and real world tasks, such as scheduling a pickup time for a user's dry cleaning on the way home from work. Real world tasks, as used herein, occur, in part, outside of computers. For example, the exchange of physical good or services is an example of a real world task. Electronic tasks occur exclusively between computing devices and users of those computing devices. Displaying through a computer display or printing the result of a computerized communication have a real world element but are, nevertheless, considered electronic tasks for this application.

The personal digital assistant application 330 can monitor other applications and operating system functions. For example, the personal digital assistant application 330 may be able to monitor or have access to sensor data from one or more sensors on the mobile device 310. For example, the personal digital assistant application 330 may have access to accelerometer data, gyro data, GPS location data, Wi-Fi location data, image data from a camera, sound data generated by a microphone, touch data from a touchscreen, and other information.

The personal digital assistant application 330 can monitor user activities within one or more other applications and store a record of this activity forming a semantic data record 331. The semantic data record 331 stores details of events performed through the smartphone or other devices running an instance of the personal digital assistant application. For example, the user could read an e-mail on their mobile device 310 causing a record of an “e-mail read” event to be created. The “e-mail read” record can describe a time and date when the email was read along with details describing the e-mail, such as the recipients, subject line, description of attachments, etc. Similar information could be used to describe a text event. A call event could record the time and date of a call, call duration, and contact information (e.g., name, phone number) for the other person on the call. The contact information could be determined from caller ID information or taken from a local contact data store when the phone number matches an existing contact's phone number.

In another example, the personal digital assistant application 330 could generate a walking event that is stored in the semantic data record 331. The absence of light from a camera could indicate that the phone is in the user's pocket and accelerometer data could indicate that the user is walking with the phone. The start time and stop time could be recorded to describe the walk event along with geographic location and/or route. The geographic information could be gathered from a GPS or other location technology within the smartphone.

A drive event could describe an instance of the user traveling in a car. As with the walking event, start and stop time of the drive event could be recorded along with geographic information such as a route. Additional information could include businesses visited before, after, or during the drive event. Geographic location information could be used to identify a business. Additionally, financial information could be gathered to confirm that a purchase was made during the drive event. A particular car may be identified by analyzing available Bluetooth connections, including when the smartphone connects to the car through a wireless or wired connection.

A specific type of drive event may include a public transportation event. The user's use of public transportation may be identifiable upon the user accessing a Wi-Fi connection provided by the transportation company. Further, route information could be analyzed to determine the user is on public transportation. For example, the route information including stops could be analyzed to determine that the route follows a bus route and the stops coincide with bus stops. Similarly, a route could be compared with a known train route to determine that public transportation is being used. Additionally, payment information may be analyzed to determine that public transportation is being used, as well as to gather additional details about the public transportation. In one instance, the payment information is provided through a near field communication system in the smartphone.

The personal digital assistant application 330 may record an entertainment event record. The location information for the smartphone may be compared with a database of known events. For example, the phone's location at a football stadium coinciding with a known ballgame event can cause an entertainment record to be created. As with other events, payment information, calendar information, e-mail information, and other data may be combined to determine that an entertainment event record should be created and to provide details. The calendar information can include a calendar description of the event. The e-mail information can include a discussion of the event with friends, a payment receipt, or other information related to the event.

Information recorded by the personal digital assistant application 330 may be considered semantic knowledge and stored in the semantic data record 331. The semantic knowledge can be used to generate an interrogation question for the purposes of authenticating a user, as described in more detail subsequently.

The secure data component 332 can authenticate a user request received by the personal digital assistant application 330 or some other application. The secure data component 332 can determine which authentication procedure needs to be used based on factors such as the task requested and the online service provider designated. The secure data component 332 can provide an interface through which the user can adjust authentication settings. The user interface may be displayed on the mobile device 310. Various authentication levels may be offered and assigned to different types of tasks. The secure data component 332 can transmit authentication settings to the secure data component 344 on the personal assistant server 340. The user may be able to specify different authentication settings for different mobile devices through which a personal digital assistant receives a request. For example, a more rigorous levels of authentication may be specified when the request is received through a mobile device, such as a smartphone, than when received through a personal computer.

The secure data component 332 determines the type of authentication required for a specific request. In one aspect, the secure data component 332 performs the authentication by generating interrogatory, receiving the user's answer, and in determining whether the user provided the correct answer to the interrogatory. Upon determining that the correct answer was received from the user, an authentication certificate may be generated by the secure data component 332 for transmission to an online service or other component that has use for the certificate. In another aspect, the interrogatory is generated by the personal digital assistant application 330 after receiving instructions about the type of interrogatory that is required to satisfy the authentication level associated with a specific request.

The personal computer 360 includes components similar to those described previously with reference to the mobile device 310. For example, the personal computer 360 includes an operating system 362, a set of applications 364, a semantic data record 371, and a secure data component 372. The set of applications includes an e-mail application 366, an action application 368, and a personal assistant application 370. These applications may be different instances of the same applications running on the mobile device 310 or be different applications altogether. For example, e-mail application 316 and e-mail application 366 could be completely different e-mail clients. The personal assistant application 370 may be an instance of a common personal assistant application optimized for different types of computing devices. In this example, both the mobile device 310 and the personal computer 360 are associated with a common user and the personal assistant application 370 can provide services based on knowledge received from the user on one or more devices associated with the user. For example, the user could submit a series of search queries through the personal computer 360 that become part of the semantic data record 371 for the user that is accessible through the personal digital assistant application 330 on the mobile device. In other words, the semantic data records can be reconciled across multiple devices.

The secure data component 372 can perform the same functions as described previously with reference to secure data component 332. As mentioned, a user or online service provider can specify different authentication mechanisms for different computing devices.

The operating system 312 and the operating system 362 may be the same operating system or be different.

The personal assistant server 340 may reside in a data center or multiple data centers. Personal assistant server 340 tracks user events and distributes data across the user's devices. The personal assistant server 340 may serve multiple users, for example, thousands, hundreds of thousands, or millions of users but is described herein in the context of a single user. The personal assistant server 340 could provide similar services for each of the multiple users served.

The user profile management component 342 is able to identify a user and a user's devices. The user profile management component 342 may provide a secure log-in for the user and allow the user to link multiple devices to the personal assistant server 340.

The secure data component 344 can manage security data, including authentication settings for a user across multiple devices. In one aspect, the secure data component 344 stores password and user credential information for various online services and provides access to this information upon validating a user request received by a personal digital assistant application running on one of a user's devices.

The security administration component 346 can update security settings for security components located on a user's devices when changes are made to the security settings on the server 340 or on one of the user's devices. The security component 346 can determine what level of authentication is required for a given request and could communicate this level to the personal digital assistant application that performs the authentication. Alternatively, the security administration component 346 could perform the authentication, including generating an interrogation question and comparing the answer received from the user to the correct answer for the interrogation.

The third-party action component 348 interfaces with third parties to perform a task or provide instructions to the third party regarding the task. The third-party action component 348 may interface with one or more application program interfaces associated with the third party's online presence to provide detailed instructions about the desired task. In one aspect, the third-party action component 348 can interface with components on a user's mobile device 310 or personal computer 360 to facilitate performance of a requested task. For example, an action application 318 on the mobile device 310 could communicate a request to the third-party action component 348 which in turn communicates with the third party's interface as needed to facilitate completion of the requested task.

The third-party security interface 350 allows online services to establish authentication procedures for tasks to be performed by the online service. The third-party security interface 350 can provide a user interface where authentication levels can be established with different tasks across multiple users associated with the personal assistant server 340. A user that has an account with the personal assistant server 340 may be considered to be associated with the personal assistant server 340.

The third-party security interface 350 can also provide confirmation that the authentication process specified by the third party has taken place in conjunction with a particular task requested. For example, the third-party security interface 350 could communicate a token, a security certificate, passwords, account information, or other security information to a third-party service upon satisfaction of an authentication procedure. In one example, the third-party security interface 350 communicates with a particular application program interface adapted to receive requests to perform tasks for the third-party service.

The semantic knowledge component 352 stores semantic knowledge gathered through the personal digital assistant. The semantic knowledge may be gathered from instances of the personal digital assistant running on one or more of a user's devices. The semantic knowledge component 352 may reconcile semantic data records on a user's various devices.

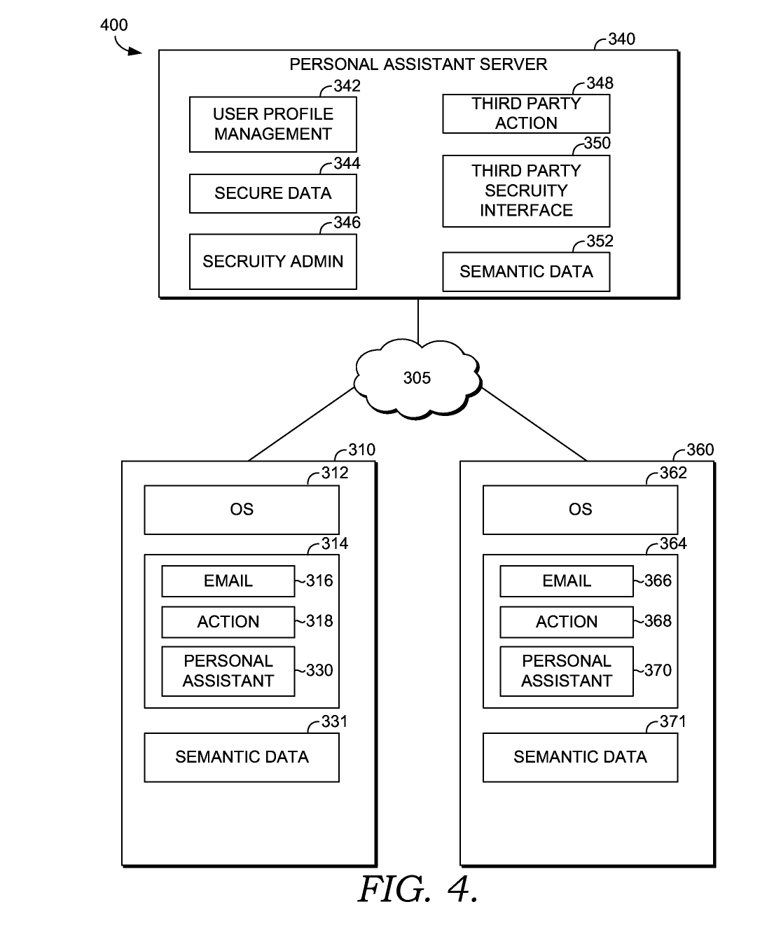

FIGS. 4-7 describe variations on the arrangement described with reference to FIG. 3. Variations other than those shown in FIGS. 3-7 are possible. Turning now to FIG. 4, a computing environment 400 with a server-centric security arrangement is shown, in accordance with an aspect of the technology described herein. Computing environment 400 comprises a personal assistant server 340, a mobile device 310, and a personal computer 360. In contrast to computing environment 300 described previously with reference to FIG. 3, only the personal assistant server 340 includes security components, such as secure data component 344, security administration component 346, and third-party security interface 350. Security data component 332 and security data component 372 (both shown in FIG. 3) are not included in computing environment 400. The server-centric security arrangement shown in FIG. 4 gives the personal assistant server 340 sole responsibility for authenticating a request to perform tasks. Personal assistant server 340 can generate an interrogation question, receive an answer from the user, and determine whether the answer is correct. The personal assistant server 340 can also manage authentication settings for various online services and user preferences.

In the server-centric arrangement of FIG. 4, personal digital assistant application 330 or personal assistant application 370 could still facilitate completion of the task upon receiving validation of the request. In addition to validation, the personal assistant server 340 could communicate user credentials stored in secure data component 344 to either of the personal digital assistants. The personal digital assistant applications 330 or 370 can then use the user credentials to complete a task through an online service.

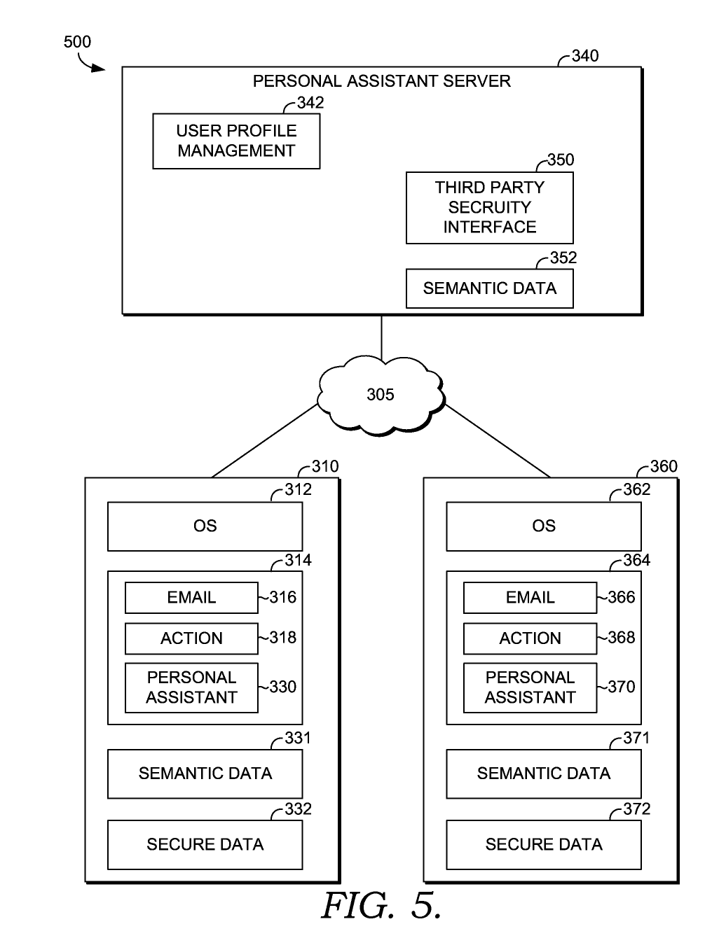

Turning now to FIG. 5, a client-centric computing environment 500 is provided, in accordance with an aspect of the technology described herein. The client-centric computing environment 500 is similar to computing environment 300 described previously. However, personal assistant server 340 does not include the secure data component 344, the security administration component 346, or the action component 348. Accordingly, in one aspect, the security information and authentication procedure is performed by the client without input from the server. The personal assistant server 340 includes third-party security interface 350 in order to provide a centralized interface for online service providers to specify authentication requirements. Once received, the requirements are then passed to the client devices and stored within secure data component 332 or secure data component 372.

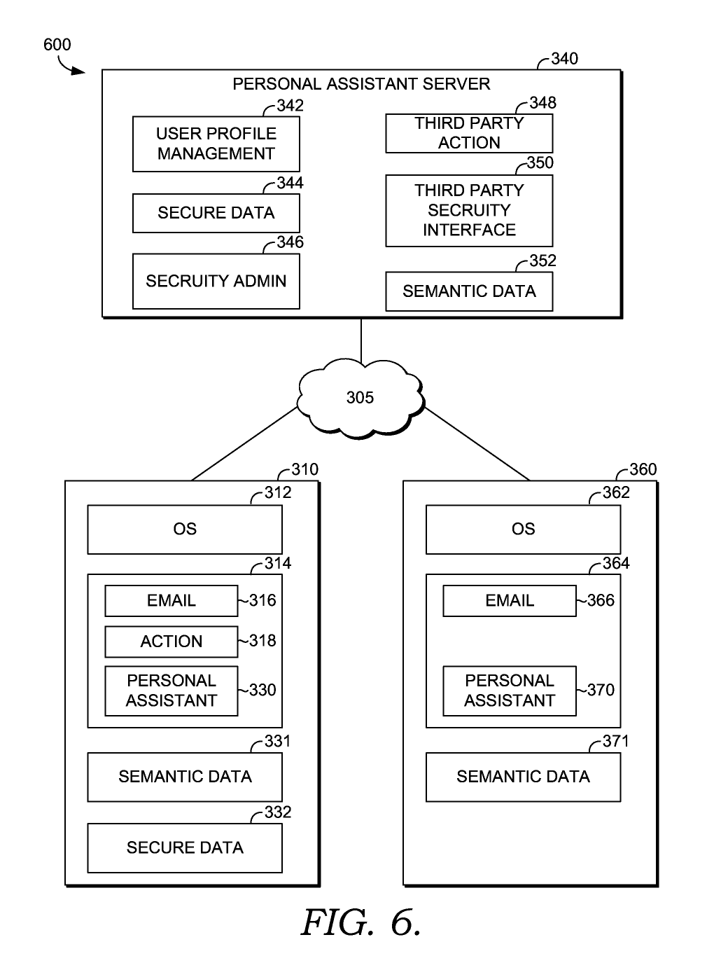

Turning now to FIG. 6, a computing environment 600 having client devices with different capabilities is shown, in accordance with an aspect of the technology described herein. Mobile device 310 includes security data component 332 while the personal computer 360 does not include a security component or an action component. In this case, semantic data gathered by the personal computer 360 could be synchronized with the semantic data stored on the mobile device 310 and the personal assistant server 340 for use in generating an interrogation and otherwise authenticating a request. However, the personal computer 360 in FIG. 6 does not have the applications installed to perform authentication. This indicates that semantic data can be gathered from computing devices other than those performing authentication, including computing devices that are incapable, for hardware or software reasons, of performing the authentication.

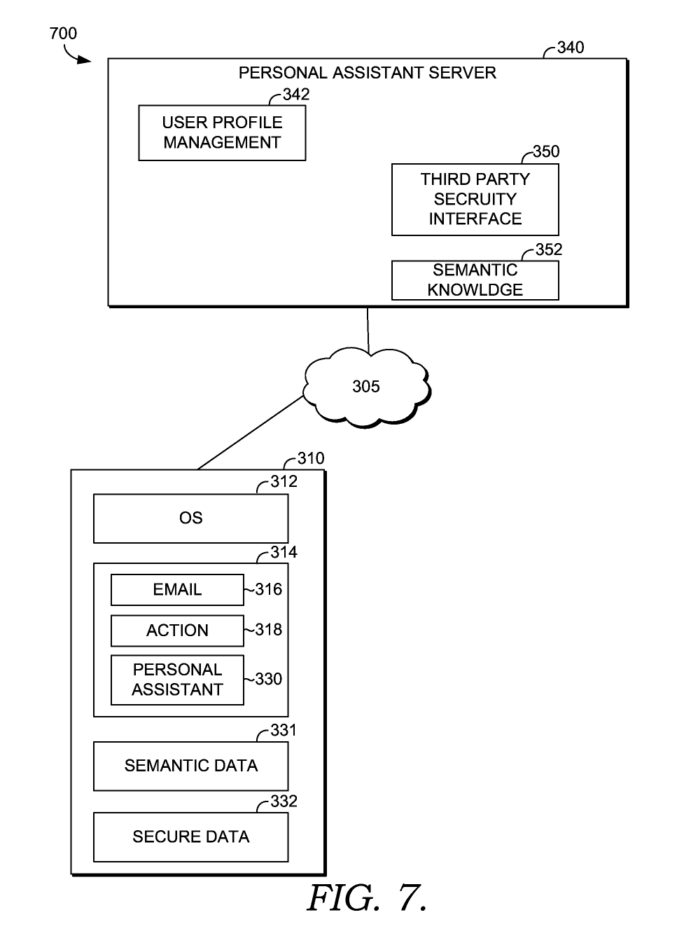

Turning now to FIG. 7, a single client device computing environment 700 is illustrated, in accordance with an aspect of the technology described herein. Computing environment 700 is also client centric with only the mobile device 310 capable of performing authentication and generating interrogation questions. The computing environment 700 illustrates that aspects of the technology described herein can operate on a single mobile device or provided in coordination with multiple devices, as illustrated previously.

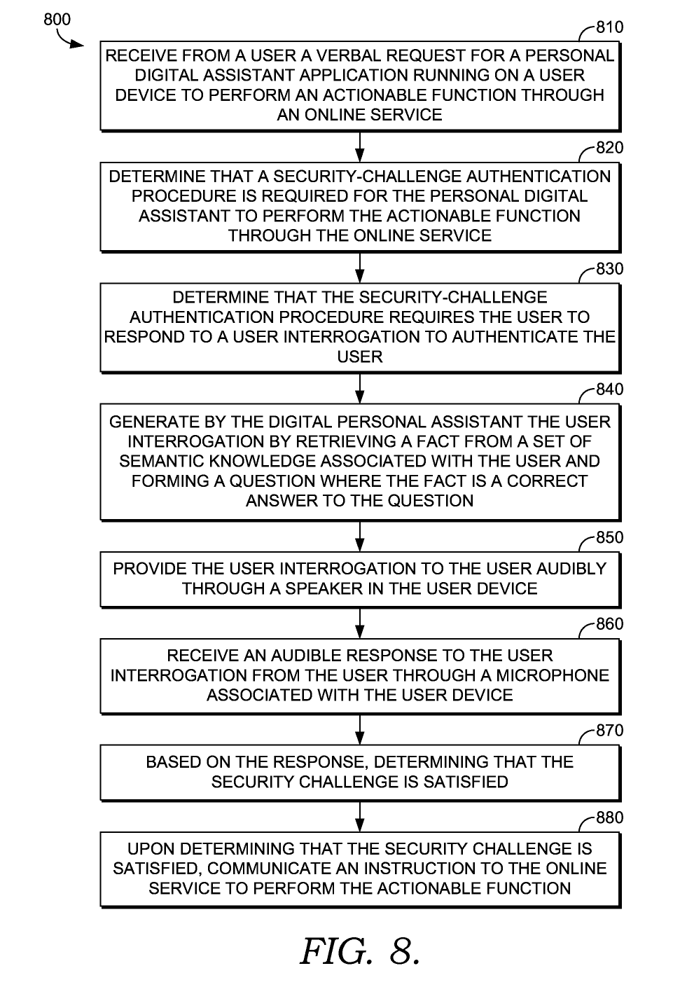

Turning now to FIG. 8, a method 800 of authenticating a request received by a personal digital assistant application is described, according to an aspect of the technology described herein. Method 800 may be performed by a computing device, such as computing device 100 or mobile device 310.

At step 810, a verbal request is received from a user. The request asks the personal digital assistant application running on a user device to perform a task through an online service. For example, the request may ask the personal digital assistant to perform the task of making a purchase through an online retailer. The online service can be any service that is accessible through an online interface, such as an Internet page, an application, or an application program interface.

In an aspect, the online service requires a password for an account associated with the user to complete the task. In this situation, carrying out the task can include retrieving the password from a security component and communicating the password to the online service. Retrieving the password or other account information from the security component can allow the personal digital assistant to perform the task without receiving the password from the user subsequent to receiving said request. The security component can store user credentials for a plurality of online services.

In an aspect, the authentication procedure described herein can be used to validate a personal assistant's authority to access the password information. In other words, the security component can be an independent check that the personal digital assistant has the authority of the account holder to access and use the password and/or other account information. To that end, the security-challenge authentication procedure described subsequently can validate that the account holder is actually making the request received by the personal digital assistant. In other words, the personal digital assistant is made to show that it has received an authenticated request from a specific user and, therefore, has authority to act on behalf of the user.

At step 820, an appropriate security-challenge authentication procedure required for the personal digital assistant to perform the task through the online service is determined. The security-challenge authentication procedure can vary according to a number of different context variables including the task to be performed and the online service through which the task is to be performed. In one aspect, the online service is able to specify the type of security-challenge authentication procedure required for the online service to accept a password and/or other account information from the personal assistant and perform the task. The online service may specify different authentication levels based on the task requested.

For example, a comparatively low level of authentication may be required to retrieve non-confidential information from the online service, such as appointment details for an existing haircut appointment. Changing the haircut appointment or making a new haircut appointment may require a medium level of authentication. Making a purchase, such as hair care products, may require a higher level of authentication. The amount of the purchase may also be considered when specifying the level of authentication required. In another example, the similarity to past purchases by the user may be used to determine the level of authentication. A request to make a purchase with a high level of similarity to one or more past purchases may require a lower level of authentication than the authentication required in response to a request to make a purchase with a low level of similarity. The level of similarity of a requested purchase to past purchases can be determined using a machine learning mechanism that is adapted for classification and trained to classify or assign a level of similarity to a new purchase and one or more past purchases. Factors considered by the machine learning mechanism when evaluating similarity can include the brand and model of an item purchased, a classification of an item purchased, delivery methods for the items purchased, delivery address for the items purchased, time of day when an item is to be picked up, the total dollar amount of the order, and such.

The levels of authentication may be specified according to standards available through the security component. For example, the security component could offer high, medium, and low authentication procedures for the online service to select from. In another aspect, detailed authentication procedure options could be provided for the online service to select. For example, the online service could require one or more biometric confirmations, such as voice authentication, facial recognition, fingerprint recognition, and such, in addition to other authentication options, such as answering an interrogation question.

In one aspect, an interface is provided for the user to specify authentication levels for various tasks. The interface can also provide an opt in or opt out to grant the personal digital assistant permission to use information within the semantic knowledge base to form interrogation questions. The interface can provide a preset level of authentication security, such as high, medium, or low, and allow the user to associate the present level of authentication with a type of task. Types of tasks can include accessing a secure account, modifying data within an account, making a purchase, making a purchase at different amounts, any task at a particular online service, and such. The interface can allow users to provide authentication levels on a per online service basis, on a per task basis, or by tasks per online service.

In an aspect, an authentication level reconciliation mechanism is provided to reconcile incompatible authentication level selections by online services and users. For example, an online service may require a minimum level of authentication for a request. The authentication level reconciliation mechanism can allow a user to select a higher level of authentication but prevent the user from selecting a level of authentication falling below the authentication level selected by the online service. An error message may be generated when a user attempts to set an authentication level below that required by an online service. Alternatively, the reconciliation mechanism may favor the user's selected authentication level over the level selected by the online service provider.

At step 830, the security-challenge authentication procedure is determined to require the user to respond to a user interrogation to authenticate the user. As used herein, the user interrogation is a question that the user has not designated and/or selected for the specific purpose of authentication and/or security. For example, a security question selected in association with setting up a user account and answered by a user is not a user interrogation for purposes of this disclosure. In addition to not selecting or designating a question used in the interrogation, the user has not provided an explicit answer to the question previously. An explicit answer is an answer provided in response to a question. For example, “Chicago” is an explicit answer to the question “where were you born.”

Information provided or generated by the user apart from the question or any question is not an explicit answer. For example, a user may generate a fact by entering a search query. Entering the search query is not an explicit answer. However, the search query could be an answer to the question “what was your last search query.”

At step 840, the digital personal assistant generates the user interrogation by retrieving a fact from a set of semantic knowledge associated with the user and forming a question where the fact is a correct answer to the question. In the example given above, the user's search history can be part of the semantic knowledge associated with the user. The user's most recent search query is an example of a fact.

Forming the question can be accomplished by selecting a question or a question template that matches the fact from a plurality of existing questions. In one aspect, a plurality of question and/or question templates is provided with corresponding facts classes or types. A question can require no modifications to elicit the fact as the correct answer. For example, “what was the last web page you visited on this device” is a question that requires no modification. The question “where did you purchase coffee this morning” could be formed from the question template “where did you purchase <item><time>,” where the item and time are retrieved from a purchase history within the semantic knowledge base and the time is the time when the item was purchased. Inserting the item and time constitutes a modification of the question template.

In one aspect, a preliminary analysis is performed to determine which questions within the plurality of existing questions have available facts within the semantic knowledge base to form a user interrogation. In other words, questions without available facts that are responsive to the question can be eliminated from consideration.

In one aspect, different questions can have different levels of authentication. In one aspect, only questions with an appropriate level of authentication for the given task are available for selection.

At step 850, the user interrogation is provided to the user audibly through a speaker in the user device. In one instance, text-to-speech technology is used to translate the question into an audible output. The text-to-speech technology may be part of the personal digital assistant's capabilities.

At step 860, an audible response to the user interrogation is received from the user through a microphone associated with the user device. For example, the user may speak the answer within range of the microphone associated with the user device. The user's audible answer may be translated into text for comparison with the fact to determine whether the correct answer was provided.

At step 870, the security challenge is determined to be satisfied by comparing the audible answer to the fact. In one aspect, the comparison allows for differences in the audible answer and the fact. For example, the fact may be “10 AM on Tuesday.” The audible answer could be “Tuesday morning.” Tuesday morning may be accepted as satisfying the fact: 10 AM. In another example, a partial match between the audible answer and the fact within the semantic knowledge base may be acceptable. For example, the audible answer “Karl's” may be an acceptable answer matching the fact “Karl's coffee shop.” Similarly, a comparison of a fact-based search query to an audible answer may be based on an n-gram comparison that looks for one or more n-grams in common As an example, the audible answer of “shoes” to the question “what was your last query” may be an acceptable answer when the last query was “men's running shoes” because both the audible answer and the last query have “shoes” in common meaning both would have an n-gram derived from shoes. In one aspect, a machine learning mechanism is used to determine whether the correct answer is provided. The machine learning mechanism can determine a similarity between the answer given and the fact. A similarity above a threshold can indicate a correct answer. Different threshold levels can be used for different authentication levels.

At step 880, upon determining that the security challenge is satisfied, an instruction is communicated to the online service to perform the task. The instruction to the online service can comprise a confirmation that the security-challenge authentication has been satisfied. The instruction can also include details about the task. In one aspect, online service providers can use an application program interface that allows for various tasks to be detailed in a way that the online service can understand and respond to. The instruction can also include a username and password retrieved from the security component after satisfaction of the selected authentication procedure.

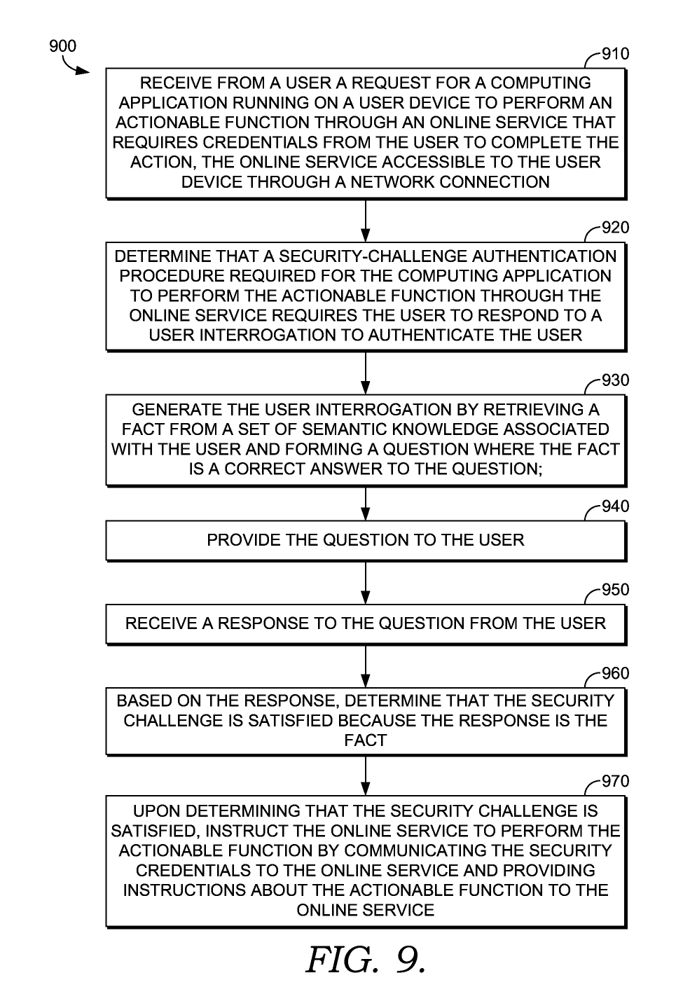

Turning now to FIG. 9, a method 900 for authorizing a digital personal assistant to conduct a transaction with a third party is provided. Method 900 may be performed by a computing device, such as computing device 100 or mobile device 310.

At step 910, a user request for a computing application running on a user device to perform a task through an online service that requires security credentials from the user to complete the action is received. The online service is accessible to the user device through a network connection to a wide area network, such as the Internet. In one aspect, the application is a personal digital assistant.

At step 920, a determination is made that a security-challenge authentication procedure required for the computing application to perform the task through the online service requires the user to respond to a user interrogation to authenticate the user. As used herein, the user interrogation is a question that the user has not designated and/or selected for the specific purpose of authentication and/or security. For example, a security question selected in association with setting up a user account and answered by a user is not a user interrogation for purposes of this disclosure. In addition to not selecting or designating a question used in the interrogation, the user has not provided an explicit answer to the question previously. An explicit answer is an answer provided in response to a question. For example, “Chicago” is an explicit answer to the question “where were you born.”

Information provided or generated by the user apart from the question or any question is not an explicit answer. For example, a user may generate a fact by entering a search query. Entering the search query is not an explicit answer. However, the search query could be an answer to the question “what was your last search query.”

In one aspect, the security-challenge authentication procedure is specific to the task, with different tasks having different security-challenge authentication procedures. For example, a purchase in a first amount may be associated with a security-challenge authentication procedure that is different from a security-challenge authentication procedure associated with a purchase in a second amount that is less than the first amount.

In one aspect, the security-challenge authentication procedure is specific to the online service, with different online services having different authentication procedures. In another aspect, the user may specify the authentication procedure to be used for different online services and/or different tasks. As mentioned above, a reconciliation mechanism may be provided when an authentication procedure specified by the online service provider conflicts with the authentication procedure selected by a user. In one aspect, the more stringent of the two authentication procedures is selected when a conflict exists.

In one aspect, the security-challenge authentication procedure is specific to an amount of money required to complete the task falling into a first range. Different security-challenge authentication procedures can be used with different money ranges.

At step 930, the user interrogation is generated by retrieving a fact from a set of semantic knowledge associated with the user and forming a question where the fact is a correct answer to the question. In one aspect, the set of semantic knowledge is generated by a personal assistant application. For example, the personal assistant application can receive and track queries, record navigation and other location information, record purchase information, and have access to a user's social network, calendar, email, and other applications or communications accessible by the personal assistant. The user may opt in or opt out of granting the personal assistant access to any given resource. The user may also opt in or opt out of granting the personal assistant access to any type of semantic data within the semantic knowledge base for the purpose of generating an interrogation. In other words, the user may grant the personal assistant access to location data for the purpose of answering a query but not for the purpose of answering or generating an interrogation used to authenticate a request.

In one aspect, the fact was added to the set of sematic knowledge within a threshold period of time from a point in time when the request is received. The threshold period of time may be described as a freshness threshold. The freshness threshold can be used to make sure that the user is likely to recall the fact from memory. Different types of data can be associated with different freshness thresholds. For example, a fact from the user's search history may be associated with a shorter freshness threshold than a fact from the user's purchase history.

In one aspect, the fact is a location visited by the user as determined by a location service running on the user device.

At step 940, the question is provided to the user. In one aspect, the question is provided to the user by audibly outputting the question through a speaker in the user device. The audible output may be generated using a text-to-speech functionality available on the user device. In one aspect, the text-to-speech functionality is part of a personal digital assistant application operating on the user device. In another aspect, the text-to-speech functionality is a standalone application that is accessed by the application performing method 900.

At step 950, a response to the question is received from the user. In one aspect, the answer is spoken by the user and received through a microphone associated with the user device. A microphone built into a user device may be associated with the user device. Similarly, a microphone built into an ear piece, headphone, watch, necklace, or other personal electronic device can be considered to be associated with the user device when it is communicatively coupled to the user device through a wired connection or wireless connection, such as Bluetooth.

At step 960, based on the response, the security challenge is determined to be satisfied because the response is the fact. In one aspect, the comparison allows for differences in the audible answer and the fact. For example, the fact may be “10 AM on Tuesday.” The audible answer could be “Tuesday morning.” Tuesday morning may be accepted as satisfying the fact: 10 AM. In another example, a partial match between the audible answer and the fact within the semantic knowledge base may be acceptable. For example, the audible answer “Karl's” may be an acceptable answer matching the fact “Karl's coffee shop.” Similarly, a comparison of a fact-based search query to an audible answer may be based on an n-gram comparison that looks for one or more n-grams in common As an example, the audible answer of “shoes” to the question “what was your last query” may be an acceptable answer when the last query was “men's running shoes” because both the audible answer and the last query have “shoes” in common meaning both would have an n-gram derived from shoes. In one aspect, a machine learning mechanism is used to determine whether the correct answer is provided. The machine learning mechanism can determine a similarity between the answer given and the fact. A similarity above a threshold can indicate a correct answer. Different threshold levels can be used for different authentication levels.

At step 970, upon determining that the security challenge is satisfied, the online service is instructed to perform the task by communicating the security credentials to the online service and providing instructions about the task to the online service. As described previously, the application performing method 900 may be granted permission to use the security credentials only after authenticating the user that submitted the request. In another aspect, the security credentials include a confirmation that the interrogation has been successfully answered. Exemplary security credentials can also include a username, password, and biometric information.

Embodiment 1. One or more computer storage media storing computer-executable instructions that, when executed by a computing device having a processor, cause the computing device to perform a method of authenticating a request received by a personal digital assistant, the method comprising: receiving from a user a verbal request for the personal digital assistant running on a user device to perform a task through an online service; determining that a security-challenge authentication procedure is required for the personal digital assistant to perform the task through the online service; determining that the security-challenge authentication procedure requires the user to respond to a user interrogation to authenticate the user; generating by the personal digital assistant the user interrogation by retrieving a fact from a set of semantic knowledge associated with the user and forming a question where the fact is a correct answer to the question; providing the user interrogation to the user audibly through a speaker in the user device; receiving an audible response to the user interrogation from the user through a microphone associated with the user device; determining that the security-challenge authentication procedure is satisfied by comparing the audible response to the fact; and upon determining that the security-challenge authentication procedure is satisfied, communicating an instruction to the online service to perform the task.

Embodiment 2. The media of embodiment 1, wherein the method further comprises: providing an interface configured to enable the user to associate one of at least two different authentication levels with the task; receiving an instruction to associate the task with a first authentication level; and assigning the first authentication level to the task within a security component.

Embodiment 3. The media of any of embodiments 1-2, wherein the online service requires a password for an account associated with the user to complete the task, and wherein said carrying out the task comprises retrieving the password from a security component that stores user credentials for a plurality of online services and communicating the password to the online service without receiving the password from the user subsequent to receiving said request.

Embodiment 4. The media of any of embodiments 1-3, wherein the method further comprises retrieving the question from a corpus of question/answer pairs that comprise a textual question and type of fact that answers the question.

Embodiment 5. The media of any of embodiments 1-4, wherein a level of the security-challenge authentication procedure is specified by the online service.

Embodiment 6. The media of embodiment 5, wherein the instruction to the online service comprises a confirmation that the security-challenge authentication procedure has been satisfied.

Embodiment 7. The media of any of embodiments 1-7, wherein the security-challenge authentication procedure further comprises performing voice recognition on the audible response.

Embodiment 8. A method for authorizing a digital personal assistant to conduct a transaction with a third party comprising: receiving from a user a request for a computing application running on a user device to perform a task through an online service that requires security credentials from the user to complete the task, the online service is accessible to the user device through a network connection; determining that a security-challenge authentication procedure required for the computing application to perform the task through the online service requires the user to respond to a user interrogation to authenticate the user; generating the user interrogation by retrieving a fact from a set of semantic knowledge associated with the user and forming a question where the fact is a correct answer to the question; providing the question to the user; receiving a response to the question from the user; based on the response, determining that the security-challenge authentication procedure is satisfied because the response is the fact; and upon determining that the security-challenge authentication procedure is satisfied, instructing the online service to perform the task by communicating the security credentials to the online service and providing instructions about the task to the online service.

Embodiment 9. The method of embodiment 8, wherein the set of semantic knowledge is generated by a personal digital assistant.

Embodiment 10. The method of any of embodiments 8-9, wherein the security-challenge authentication procedure is specific to the task, with different tasks having different security-challenge authentication procedures.

Embodiment 11. The method of any of embodiments 8-10, wherein the security-challenge authentication procedure is specific to the online service, with different online services having different security-challenge authentication procedures.

Embodiment 12. The method of any of embodiments 8-11, wherein the security-challenge authentication procedure is specific to an amount of money required to complete the task falling into a first range, wherein different security-challenge authentication procedures are used with different money ranges.

Embodiment 13. The method of any of embodiments 8-12, wherein the fact was added to the set of semantic knowledge within a threshold period of time from a point in time when the request is received.

Embodiment 14. The method of any of embodiments 8-13, wherein the fact is a location visited by the user as determined by a location service running on the user device.

Embodiment 15. The method of any of embodiments 8-14, wherein the set of semantic knowledge is not explicitly provided by the user for generating the user interrogation.

Embodiment 16. A mobile computing device comprising a computer memory and a computer processor that is configured to allow a personal digital assistant to perform tasks with an online service upon validating a user instruction, the mobile computing device comprising: the personal digital assistant that is a computer program stored on the computer memory having code configured to: (1) receive an audible request for the personal digital assistant to perform a task through the online service, the online service accessible to the mobile computing device through a network connection; (2) determine that a security-challenge authentication procedure required for the personal digital assistant to perform the task through the online service requires a user to respond to a user interrogation to authenticate the user; (3) generate the user interrogation which comprises a question having a correct answer by retrieving a fact from a set of semantic knowledge associated with the user and forming the question where the fact is the correct answer to the question; (4) provide the question to the user; (5) receive a response to the question from the user; (6) determine that the security-challenge authentication procedure is satisfied because the response is the correct answer; and (7) instruct the online service to perform the task by communicating security credentials to the online service that confirm that the security-challenge authentication procedure has been satisfied and providing instructions about the task to the online service.

Embodiment 17. The mobile computing device of embodiment 16, wherein the security-challenge authentication procedure is specific to the online service, with different online services having different security-challenge authentication procedures.

Embodiment 18. The mobile computing device of any of embodiments 16-17, wherein the security-challenge authentication procedure is specific to an amount of money required to complete the task falling into a first range, wherein different security-challenge authentication procedures are used with different money ranges.

Embodiment 19. The mobile computing device of any of embodiments 16-18, wherein the set of semantic knowledge is not explicitly provided by the user for generating the user interrogation.

Embodiment 20. The mobile computing device of any of embodiments 16-19, wherein the set of semantic knowledge is generated by the personal digital assistant.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A mobile computing device comprising a computer memory and a computer processor that is configured to allow a personal digital assistant to perform tasks with an online service upon validating a user instruction, the mobile computing device comprising:
the personal digital assistant that is a computer program stored on the computer memory having code configured to:
(1) receive an audible request for the personal digital assistant to perform a task through the online service, the online service accessible to the mobile computing device through a network connection;
(2) determine that a security-challenge authentication procedure required for the personal digital assistant to perform the task through the online service requires a user to respond to a user interrogation to authenticate the user;
(3) generate the user interrogation which comprises a question having a correct answer by retrieving a fact from a set of semantic knowledge associated with the user and forming the question where the fact is the correct answer to the question;
(4) provide the question to the user;
(5) receive a response to the question from the user;
(6) determine that the security-challenge authentication procedure is satisfied because the response is the correct answer; and
(7) instruct the online service to perform the task by communicating security credentials to the online service that confirm that the security-challenge authentication procedure has been satisfied and providing instructions about the task to the online service.

2. The mobile computing device of claim 1, wherein the security-challenge authentication procedure is specific to the online service, with different online services having different security-challenge authentication procedures.

3. The mobile computing device of claim 1, wherein the security-challenge authentication procedure is specific to an amount of money required to complete the task falling into a first range, wherein different security-challenge authentication procedures are used with different money ranges.

4. The mobile computing device of claim 1, wherein the set of semantic knowledge is not explicitly provided by the user for generating the user interrogation.

5. The mobile computing device of claim 1, wherein the set of semantic knowledge is generated by the personal digital assistant.

6. One or more computer storage media storing computer-executable instructions that, when executed by a computing device having a processor, cause the computing device to perform a method of authenticating a request received by a personal digital assistant, the method comprising:
receiving from a user a verbal request for the personal digital assistant running on a user device to perform a task through an online service;
determining that a security-challenge authentication procedure is required for the personal digital assistant to perform the task through the online service;
determining that the security-challenge authentication procedure requires the user to respond to a user interrogation to authenticate the user;
generating by the personal digital assistant the user interrogation by retrieving a fact from a set of semantic knowledge associated with the user and forming a question where the fact is a correct answer to the question;
providing the user interrogation to the user audibly through a speaker in the user device;
receiving an audible response to the user interrogation from the user through a microphone associated with the user device;
determining that the security-challenge authentication procedure is satisfied by comparing the audible response to the fact; and
upon determining that the security-challenge authentication procedure is satisfied, communicating an instruction to the online service to perform the task.

7. The media of claim 6, wherein the method further comprises:
providing an interface configured to enable the user to associate one of at least two different authentication levels with the task;
receiving an instruction to associate the task with a first authentication level; and
assigning the first authentication level to the task within a security component.

8. The media of claim 6, wherein the online service requires a password for an account associated with the user to complete the task, and wherein said carrying out the task comprises retrieving the password from a security component that stores user credentials for a plurality of online services and communicating the password to the online service without receiving the password from the user subsequent to receiving said request.

9. The media of claim 6, wherein the method further comprises retrieving the question from a corpus of question/answer pairs that comprise a textual question and type of fact that answers the question.

10. The media of claim 6, wherein a level of the security-challenge authentication procedure is specified by the online service.

11. The media of claim 10, wherein the instruction to the online service comprises a confirmation that the security-challenge authentication procedure has been satisfied.

12. The media of claim 6, wherein the security-challenge authentication procedure further comprises performing voice recognition on the audible response.

13. A method for authorizing a digital personal assistant to conduct a transaction with a third party comprising:
receiving from a user a request for a computing application running on a user device to perform a task through an online service that requires security credentials from the user to complete the task, the online service is accessible to the user device through a network connection; determining that a security-challenge authentication procedure required for the computing application to perform the task through the online service requires the user to respond to a user interrogation to authenticate the user;
generating the user interrogation by retrieving a fact from a set of semantic knowledge associated with the user and forming a question where the fact is a correct answer to the question;
providing the question to the user;
receiving a response to the question from the user;
based on the response, determining that the security-challenge authentication procedure is satisfied because the response is the fact; and
upon determining that the security-challenge authentication procedure is satisfied, instructing the online service to perform the task by communicating the security credentials to the online service and providing instructions about the task to the online service.

14. The method of claim 13, wherein the set of semantic knowledge is generated by a personal digital assistant.

15. The method of claim 13, wherein the security-challenge authentication procedure is specific to the task, with different tasks having different security-challenge authentication procedures.

16. The method of claim 13, wherein the security-challenge authentication procedure is specific to the online service, with different online services having different security-challenge authentication procedures.

17. The method of claim 13, wherein the security-challenge authentication procedure is specific to an amount of money required to complete the task falling into a first range, wherein different security-challenge authentication procedures are used with different money ranges.

18. The method of claim 13, wherein the fact was added to the set of semantic knowledge within a threshold period of time from a point in time when the request is received.

19. The method of claim 13, wherein the fact is a location visited by the user as determined by a location service running on the user device.

20. The method of claim 13, wherein the set of semantic knowledge is not explicitly provided by the user for generating the user interrogation.
